(19) United States
(12) Patent Application Publication
(10) Pub. No.: US 2014/0250622 A1
(43) Pub. Date: Sep. 11, 2014

(54) WINDSHIELD WIPER ASSEMBLY

(71) Applicant: MITSUBA CORPORATION, Gunma (JP)

(72) Inventors: Tetsuya TAJIMA, Novi, MI (US); Takamichi IIZUKA, Novi, MI (US)

(73) Assignee: MITSUBA CORPORATION, Gunma (JP)

(21) Appl. No.: 13/790,314

(22) Filed: Mar. 8, 2013

(51) Int. Cl. B60S 1/08

(52) U.S. Cl. CPC B60S 1/08
USPC 15/250.31

(57) ABSTRACT

A windshield wiper assembly for a vehicle includes a bar, a wiper motor mounted on one side of the bar, and a pair of pivot shafts arranged on the one side of the bar. The windshield wiper assembly has an easy layout, and the pivot assemblies, the wiper motor and the link mechanism are all located in the same direction relative to the bar.

### BACKGROUND

The present invention generally relates to a windshield wiper assembly.

FIGS. 6 and 7 illustrate conventional a windshield wiper assembly. As shown in FIGS. 6 and 7, the windshield wiper assembly 200 of the prior art is mounted to a vehicle 300. The windshield wiper assembly 200 typically includes a wiper motor 210, pivot assemblies 220, 230, a pair of pivot shafts 221, 231 pivotally supporting pivot assemblies 220, 230, body fixing portions 222, 232 mounted to a cowl box 310 of the vehicle 300, a pivotable linkage mechanism 240, and a bar 250.

The pivotable link mechanism 240 is commonly composed of a plurality of interconnected link rods 241, 242. The link rods 241, 242 are pivotally connected to the wiper motor 210. Rotational movement of the wiper motor 210 is converted to pivotal movement of the link mechanism 240, which in turn pivots the wiper arms and blades. The wiper motor 210 has a body fixing pin 211 integrally formed therewith.

The windshield wiper assembly 200 is mounted within the cowl box 310 of the vehicle 300. To wipe a windshield 330 with the wiper blades effectively, each pivot shaft 221 is located near the lower end 331 of the windshield 330.

When the current trend of automobile manufactures designing vehicles with the windshield moved from the current position (i.e., the position of the windshield 330) to a new position (i.e., the position of the windshield 1330), the pivot shaft needs to be moved from the current position (i.e., the position of the pivot shaft 221) to a new position (i.e., the position of the pivot shaft 1221) near the lower end 1331 of the newly positioned windshield 1330.

It would be desirable to use an existing windshield wiper assembly with the newly positioned windshield 1330. However, if the wiper motor, the body fixing portion and the frame of the wiper motor assembly are to remain in the same positions relative to one another, it would only be necessary to move the pivot assemblies 220, 230. However, according to the prior art, the body fixing pin 211, 1221 needs to be inserted into a vehicle interior side panel 320, 1320 of the cowl box 310, 1310. As a result, the entire windshield wiper assembly 200, 1200 must be moved. Also, the link mechanism 240 must not interfere with anything while in the new position 1320 relative to the panel. As a result, the prior art windshield wiper assembly 1200 has a limited amount of design freedom for the layout of the link mechanism. Thus, it would be necessary to redesign the entire windshield wiper assembly (e.g., the pivot assemblies, the frame, etc.).

### SUMMARY

One aspect of the invention overcomes many limitations and disadvantages of the related art windshield wiper assembly for use in connection with a vehicle. To this end, a windshield wiper assembly for a vehicle is provided. The windshield wiper assembly includes a frame, a wiper motor mounted on one side of the frame, and a pair of pivot shafts arranged on the one side of the frame. Advantageously, it is easy to lay out the windshield wiper assembly, and the pivot assemblies, the wiper motor and the link mechanism are all located in the same direction relative to the frame.

### BRIEF DESCRIPTION OF THE DRAWINGS

FIG. 1 is a perspective view of a cut away cowl cover plate which shows a windshield wiper assembly in the mounted state according to an embodiment of the present invention.

FIG. 2 is a front view of the windshield wiper assembly according to a first embodiment of the present invention.

FIG. 3 is a side view of the wiper windshield assembly according to the first embodiment of the present invention.

FIG. 4 is a side view of a position of a cowl body of a vehicle and a windshield wiper assembly of the present invention.

FIG. 5 is a front view of an alternative embodiment of the windshield wiper assembly according to the present invention.

FIG. 6 is a front view of a windshield wiper assembly of the related art.

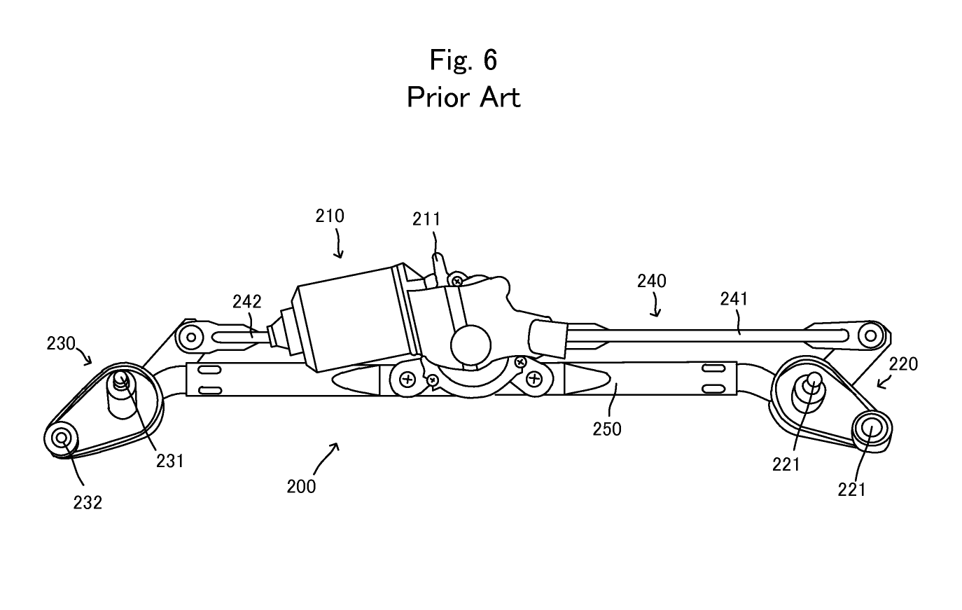

FIG. 7 is a side view of a position of a cowl body of a vehicle and a windshield wiper assembly of the related art.

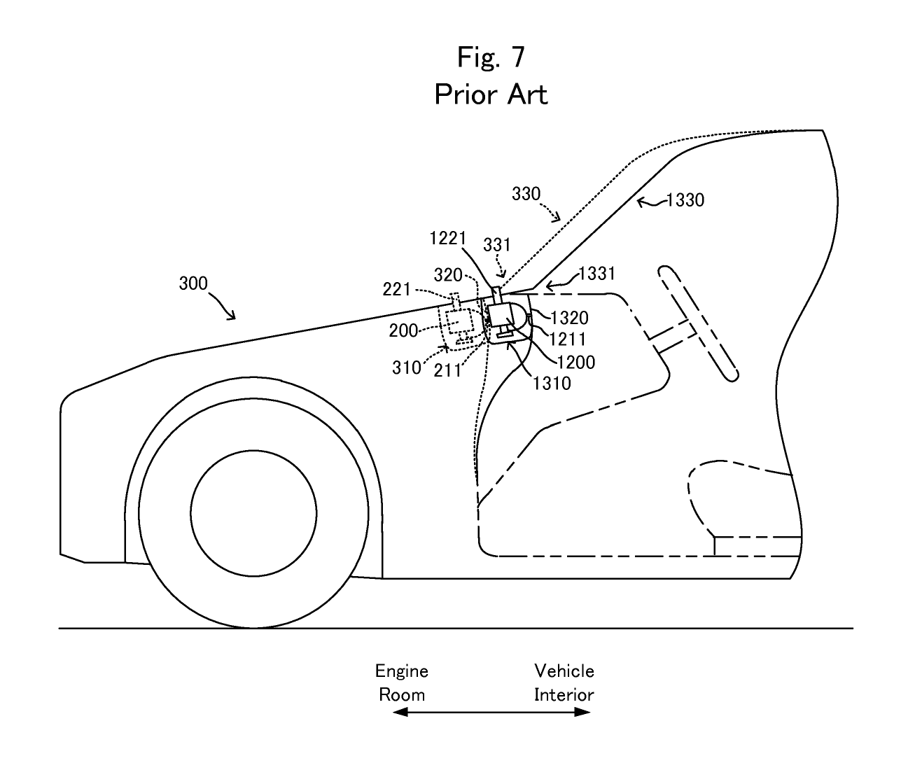

### DESCRIPTION OF EXEMPLARY EMBODIMENTS

Embodiments of the invention will be explained with reference to the drawings.

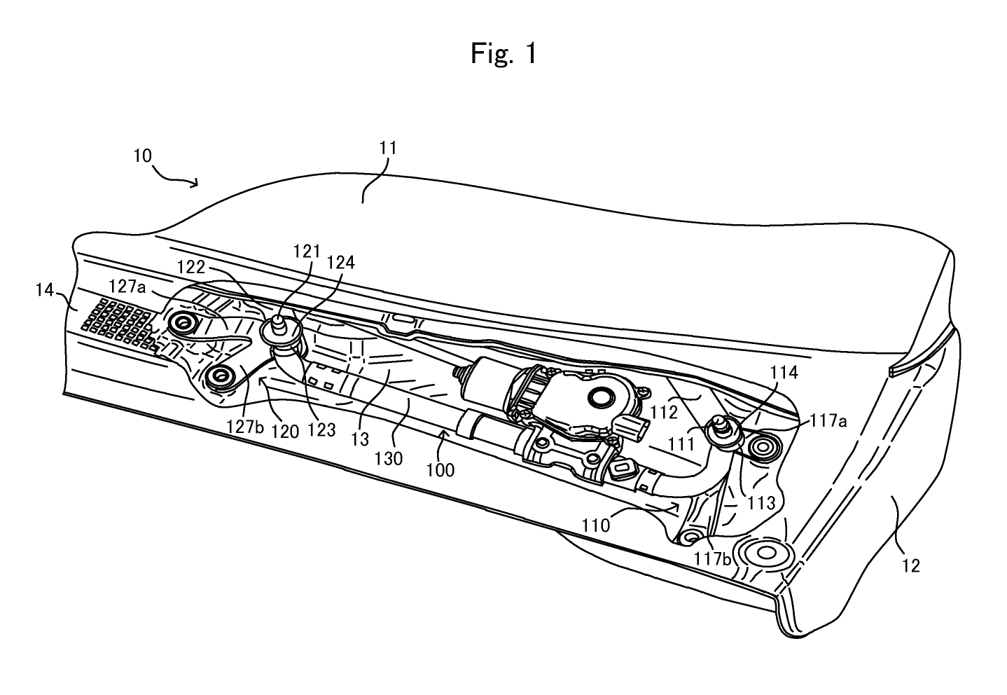

As shown in FIG. 1, a vehicle 10 includes a windshield 11 and a body panel 12. The body panel 12 includes a cowl box 13 and a cowl cover plate 14 which covers the cowl box 13. A windshield wiper assembly 100 is mounted within the cowl box 13.

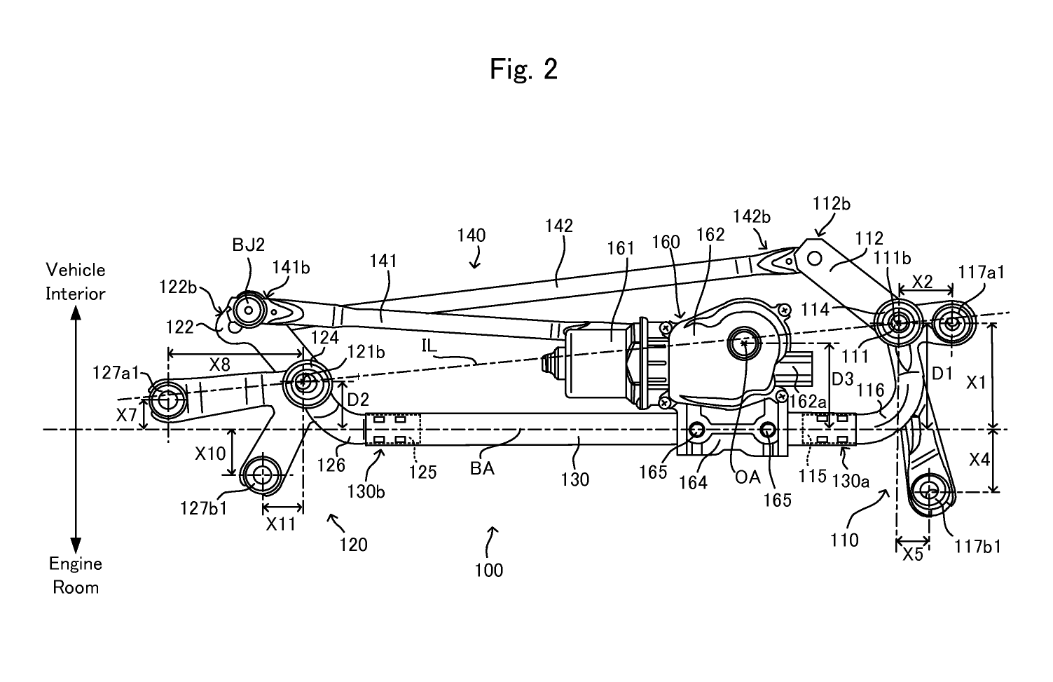

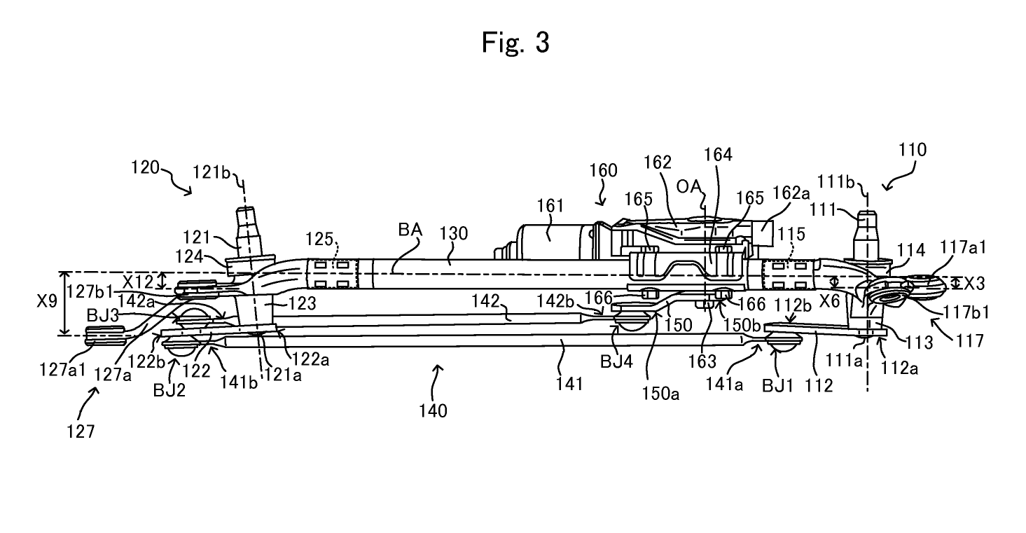

As shown in FIGS. 2 and 3, the windshield wiper assembly 100 includes a first pivot assembly 110, which includes a first pivot shaft 111, a first pivot lever 112, a first shaft supporting portion 113, a first pivot cap 114, a first bar coupling portion 115, a first offset arm 116, and a first body fixing part 117.

Also, the windshield wiper assembly 100 includes a second pivot assembly 120, which includes a second pivot shaft 121, a second pivot lever 122, a second shaft supporting portion 123, a second pivot cap 124, a second bar coupling portion 125, a second offset arm 126, and a second body fixing part 127. Further, the windshield wiper assembly 100 includes a bar 130 and a link mechanism 140.

Details of each of these structures are described below.

The first and second pivot shafts 111 and 121 are preferably formed of metal, and have an elongated cylindrical shape. The first and second pivot levers 112 and 122 are preferably formed of metal, and have a rectangular and thin plate shape.

A first end 111a of the first pivot shaft 111 is coupled to a first end 112a of the first pivot lever 112. A first ball joint BJ1 is coupled to a second end 112b of the first pivot lever 112. A first end 121a of the second pivot shaft 121 is coupled to a first end 122a of the second pivot lever 122. A second ball joint BJ2 is coupled to a second end 122b of the second pivot lever 122.

The link mechanism 140 is pivotally connected to the first pivot lever 112 via the first ball joint BJ1. The first and second ball joints BJ1 and BJ2 also include a limiter for controlling rotation in predetermined range corresponding to each lever.

The first and second shaft supporting portions 113 and 123 are preferably formed of metal or plastic, and have a cylindrical bore shape. The first pivot shaft 111 is inserted into the first shaft supporting portion 113 so that the first pivot shaft 111 is pivotally supported by the first shaft supporting portion 113. The second pivot shaft 121 is also inserted into the second shaft supporting portion 123 so that the second pivot shaft 121 is pivotally supported by the second shaft supporting portion 123.

The first pivot cap 114 is attached to the first pivot shaft 111 or the first shaft supporting portion 113 so that grease is encased by the first pivot cap 114. The second pivot cap 124 is attached to the second pivot shaft 121 or the second shaft supporting portion 123 so that grease is encased by the second pivot cap 124. By providing the first and second pivot caps 114 and 124, fluid (e.g., rain water, melting snow, washing fluid, and the like) is prevented from splashing on or encroaching between the first pivot shaft 111 and the first shaft supporting portion 113, and between the second pivot shaft 121 and the second shaft supporting portion 123.

The first and second bar coupling portions 115 and 125 are preferably formed of metal or plastic, and are integrally formed with the first and second shaft supporting portions 113 and 123 so that they project outwardly from sides of the first and second shaft supporting portions 113 and 123. The first and second bar coupling portions 115 and 125 are generally an elongated cylinder, for example, 23 mm in diameter, with a circular cross-section, and are coupled to both ends of the bar 130 by any suitable method of fixing such as press-fitting, staking, or via threaded fasteners.

The first and second pivot assemblies 110 and 120 have first and second offset arms 116 and 126. The first and second pivot shafts 111 and 121 are laterally offset from the first and second bar coupling portions 115 and 125.

In a plane perpendicular to a longitudinal output shaft axis OA, a first distance of a perpendicular line extending from an axis of the first bar coupling portion 115 to a longitudinal first pivot shaft axis 111b is D1. D1 may be, for example, approximately 80 mm. Also, a second distance of a perpendicular line from an axis of the second bar coupling portion 125 to a longitudinal second pivot shaft axis 121b is D2. D2 may be, for example, approximately 30 mm.

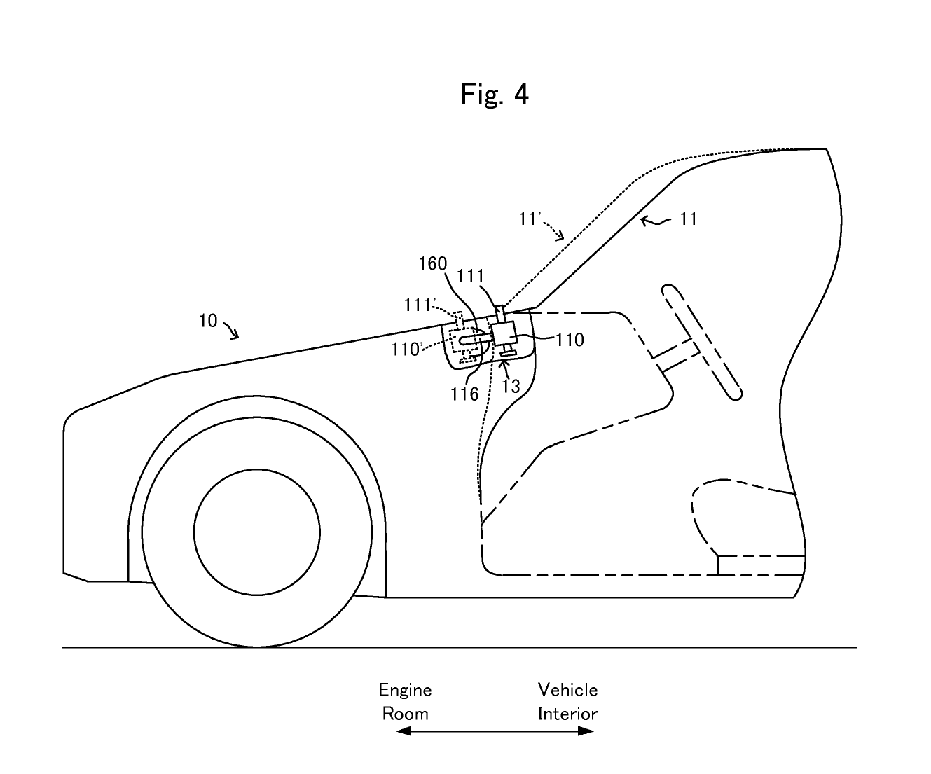

The first offset arm 116 is integrally formed with the first shaft supporting portion 113 and the first bar coupling portion 115. The first offset arm 116 is curved, and has a radius of, for example, 30 mm as seen from the plane perpendicular to a longitudinal axis OA. Also, the second offset arm 126 is integrally formed with the second shaft supporting portion 123 and the second bar coupling portion 125. The second offset arm 126 is curved, and has the radius of 30 mm as seen from the plane perpendicular to a longitudinal axis OA. As shown in FIGS. 1 to 4, in case of the body fixing portion 117, 118 and the bar 130 and the wiper motor 160 remaining in the same position as in prior designs, only the pivot assemblies are moved from the current position 110′ to the new position 110 to work with a windshield that has been moved from the current position 11′ to a new position 11. The second pivot assembly 120 is not shown in FIG. 4. Also, the current position is shown with a dotted-line, and the new position is shown with a solid line.

The first and second body fixing parts 117 and 127 are preferably formed of metal or plastic, and are integrally formed with the first and second shaft supporting portions 113 and 123. The first and second parts 117 and 127 are mounted on the cowl box 13 by, for example, bolts. As such, the first and second bar coupling portions 115 and 125 are maintained stationary relative to the cowl box 13 while the first and second pivot levers 112 and 122 are pivotable about the first and second pivot shafts 111 and 121.

The bar 130 is preferably formed of metal, and is generally an elongated straight cylinder, for example, 25 mm in diameter, with a circular cross-section that is cut to a predetermined length. The first bar coupling portion 115 is coupled to a first end 130a of the bar 130 by, for example, press-fitting or staking. The axis of the first bar coupling portion 115 nearly coincides with the axis of the first end 130a.

Also, the second bar coupling portion 125 is coupled to a second end 130b of the bar 130 by, for example, press-fitting or staking. Also, the axis of the second bar coupling portion 125 nearly coincides with the axis of the second end 130b. As illustrated, the first and second bar coupling portions 115 and 125 may be inserted within both ends 130a, 130b to enhance the interconnection therebetween.

The wiper motor 160 is directly mounted on one side of the bar 130, and between the first and second bar coupling portions 115 and 125 by, for example, bolts 165, 165.

The link mechanism 140 includes first and second link rods 141 and 142. The first and second link rods 141 and 142 are preferably formed of metal although other materials may substitute therefor. The second end 112b is pivotally connected to a first end 141a of the first link rod 141 via the first ball joint BJ1.

The second end 122b is pivotally connected to a second end 141b of the first link rod 141 via the second ball joint BJ2. The second end 122b is pivotally connected to a first end 142a of the second link rod 142 via a third ball joint BJ3 which is attached to the opposite side of the second ball joint BJ2. A first end 150a of the crank arm 150 is pivotally connected to a second end 142b of the second link rod 142.

The wiper motor 160 includes a motor case 161 coupled to a gear case 162. The gear case 162 has a coupler 162a for supplying the wiper motor 160 with the current to move the wiper motor 160. When the wiper motor 160 is driven, an output shaft 163 which is accommodated in the gear case 162 rotates around the output shaft axis OA. A bar coupling portion 164 for coupling the gear case 162 to the bar 130 is operatively associated with the gear case 162. The gear case 162 is coupled to the bar 130 by coupling points, for example, bolts 165, 165 and nuts 166, 166, securing the bar coupling portion 164 to the bar 130.

The crank arm 150 is preferably metal, and has a rectangular plate shape. The distal end of the output shaft 163 is coupled to a second end 150b of the crank arm 150. A fourth ball joint BJ4 is coupled to the first end 150a. The second end 142b is pivotally connected to the first end 150a via the fourth ball joint BJ4.

As shown in FIGS. 2 and 3, the first and second pivot assemblies 110 and 120 have the first and second shaft supporting portions 113 and 123, the first and second bar coupling portions 115 and 125, and the first and second body fixing parts 117 and 127. The first and second pivot shafts 111 and 121 and the output shaft 163 are arranged on one side of the bar 130.

The first bar coupling portion 115 extends outwardly from the first shaft supporting portion 113. In a plane perpendicular to the output shaft axis OA, a first distance of a perpendicular line from an axis of the first bar coupling portion 115 to the longitudinal first pivot shaft axis 111b is D1. D1 may be, for example, approximately 80 mm.

The second bar coupling portion 125 also extends outwardly from the second shaft supporting portion 123. In the plane perpendicular to the output shaft axis OA, a second distance of a perpendicular line from an axis of the second bar coupling portion 125 to the longitudinal second pivot shaft axis 121b is D2. D2 may be, for example, approximately 30 mm.

As the bar 130 has an elongated straight cylinder, a longitudinal axis BA of the bar 130 is straight. In other words, the axis of the first bar coupling portion 115 is approximately coincident with the axis of the second bar coupling portion 125.

The first and second distances D1 and D2 from the bar axis BA may be modified according to the shape of the windshield 10. In this embodiment, the windshield wiper assembly 100 is for a left-hand drive vehicle. In case of a right-hand drive vehicle, the windshield wiper assembly is symmetrical to the center of the vehicle overall width.

In the plane perpendicular to the output shaft axis OA, a third distance of the perpendicular line from the output shaft axis OA to the bar axis BA is D3. D3 may be, for example, approximately 60 mm. The output shaft axis OA is set in the same direction as the first and second pivot shafts 111 and 121. Further, the output shaft axis OA is located approximately linearly to the imaginary line IL between the first and second pivot shafts 111 and 121. Furthermore, the wiper motor 160 is located between the first and second pivot assemblies 110 and 120 as seen from the bar axis BA.

When a perpendicular distance from the first pivot shaft 111 to the bar axis BA is represented by D1, a perpendicular distance from the second pivot shaft 121 to the bar axis BA is represented by D2, and a perpendicular distance from the output shaft 163 to the bar axis BA is represented by D3, a relationship D2<D3<D1 is satisfied in a plane perpendicular to the output shaft axis OA.

Furthermore, the wiper motor 160 does not have a body fixing pin. Instead, the windshield wiper assembly 100 is only coupled to the cowl box 13 by bolts at the first and second body fixing parts 117 and 127. Thus, as the position of the windshield changes according to manufacturer's designs, no special attention need be paid to the cowl box 13 for a body fixing pin of the wiper motor.

Also, the link mechanism 140 is freely arranged in the direction of the vehicle interior. Further, the windshield wiper assembly 100 is compact because the wiper motor 160 is located between the first and second pivot assemblies 110 and 120. Furthermore, the coupler 162a is easily attached to the wiper motor 160 in the direction of the first pivot assembly 110.

As shown FIGS. 2 and 3, the first body fixing part 117 has first and second legs 117a and 117b. The first and second legs 117a and 117b have first and second fixing parts 117a1 and 117b1 attached to the cowl box 13 by a bolt at the distal ends thereof.

Further, the second body fixing part 127 has first and second legs 127a and 127b. The first and second legs 127a and 127b have first and second fixing parts 127a1 and 127b1 attached to the cowl box 13 by a bolt at the distal ends thereof.

In the plane perpendicular to the output shaft axis OA, the distance of a perpendicular line from the first fixing part 117a1 to the extended line of the bar axis BA is X1. X1 may be, for example, approximately 80 mm. Also, the distance of a perpendicular line from the first fixing part 117a1 to the line which is perpendicular to the bar axis BA through the first pivot shaft axis 111b is X2. X2 may be, for example, approximately 40 mm. In the longitudinal direction of the first pivot shaft 111, the distance of a perpendicular line from the first fixing part 117a1 to the extended line of the bar axis BA is X3. X3 may be, for example, approximately 20 mm.

In the plane perpendicular to the output shaft axis OA, the distance of a perpendicular line from the second fixing part 117b1 to the extended line of the bar axis BA is X4. X4 may be, for example, approximately 50 mm. Also, the distance from the second fixing part 117b1 to the line which is perpendicular to the bar axis BA through the first pivot shaft axis 111b is X5. X5 may be, for example, approximately 25 mm. As shown in FIG. 3, in the longitudinal direction of the first pivot shaft 111, the distance of a perpendicular line from the second fixing part 117b1 to the extended line of the bar axis BA is X6. X6 may be, for example, approximately 20 mm.

In the plane perpendicular to the output shaft axis OA, the distance of a perpendicular line from the first fixing part 127a1 to the extended line of the bar axis BA is X7. X7 may be, for example, approximately 30 mm. Also, the distance from the first fixing part 127a1 to the line which is perpendicular to the bar axis BA through the second pivot shaft axis 121b is X8. X8 may be, for example, approximately 100 mm. In the longitudinal direction of the second pivot shaft 121, the distance of the perpendicular line from the first fixing part 127a1 to the extended line of the bar axis BA is X9. X9 may be, for example, approximately 50 mm.

In the plane perpendicular to the output shaft axis OA, the distance of a perpendicular line from the second fixing part 127b1 to the extended line of the bar axis BA is X10. X10 may be, for example, approximately 30 mm. Also, the distance from the second fixing part 127b1 to the line which is perpendicular to the bar axis BA through the second pivot shaft axis 121b is X11. X11 may be, for example, approximately 35 mm. As shown in FIG. 3, in the longitudinal direction of the second pivot shaft 121, the distance of the perpendicular line form the second fixing part 127b1 to the extended line of the bar axis BA is X12. X12 may be, for example, approximately 25 mm.

In the plane perpendicular to the output shaft axis OA, the first fixing part 117a1 of the first leg 117a and the first fixing part 127a1 of the second leg 127a are preferably located approximately linearly to the imaginary line IL or an extended line of the imaginary line IL. Because tools do not disturb the windshield 10 when the windshield wiper assembly 100 is mounted within the cowl box 13, each offset arm is not limited to one curved part and, for example, more than two curved parts, or more than one right angle part may be used.

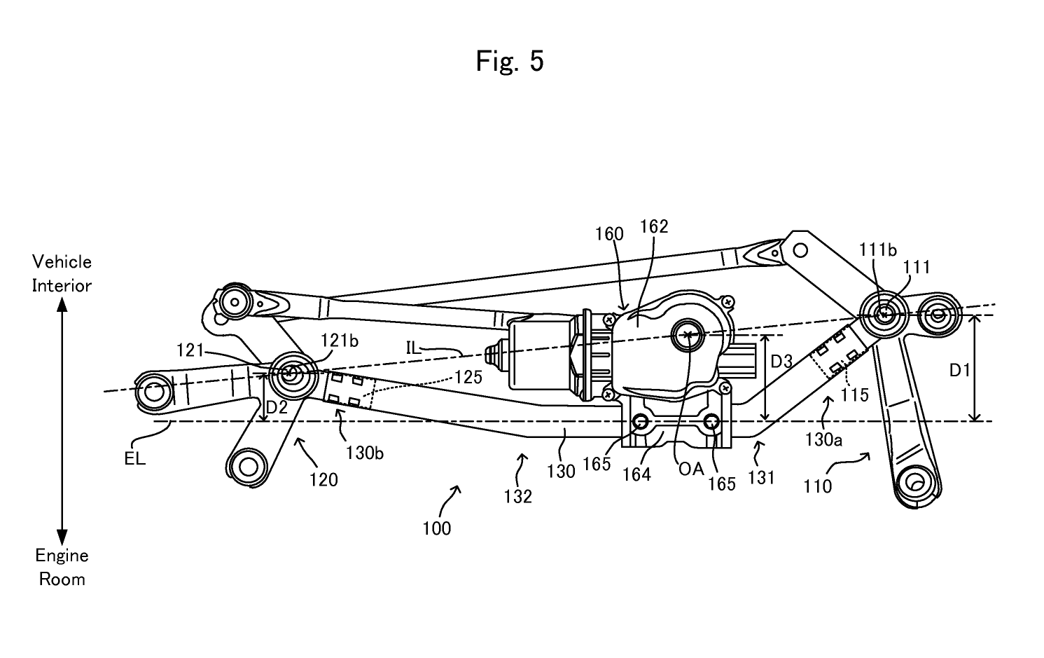

As shown in FIG. 5, the bar axis BA is replaced with an extended line EL of a line between the coupling points, for example, the two bolts 165, 165, of the bar coupling portion 164. The bar 130 has first and second bending parts 131 and 132, and is coupled to the coupling points 165, 165. An angle of the first bending part 131 relative to the extended line EL is approximately 40 degrees. An angle of the second bending part 132 relative to the extended line EL is approximately 15 degrees. Each bending part is not limited to one bending part and, for example, more than two bending parts, or more than one right angle part may be used.

In a plane perpendicular to the output shaft axis OA, a first distance of a perpendicular line from a longitudinal first pivot shaft axis 111b to the extended line EL is D1. D1 may be, for example, approximately 80 mm. A second distance of a perpendicular line from a longitudinal second pivot shaft axis 121b to the extended line EL is D2. D2 may be, for example, approximately 30 mm. A third distance of the perpendicular line from the output shaft axis OA to the extended line EL is D3. D3 may be, for example, approximately 60 mm.

When a perpendicular distance from the first pivot shaft 111 to the extended line EL is represented by D1, a perpendicular distance from the second pivot shaft 121 to the extended line EL is represented by D2, and a perpendicular distance from the output shaft 163 to the extended line EL is represented by D3, a relationship D2<D3<D1 is satisfied in a plane perpendicular to the output shaft axis OA.

The windshield wiper assembly 100 being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A windshield wiper assembly, comprising:
a wiper motor;
a bar coupled to the wiper motor, the bar being elongated along a longitudinal axis;
a first pivot assembly coupled to a first end of the bar, the first pivot assembly having a first pivot shaft; and
a second pivot assembly coupled to a second end of the bar, the second pivot assembly having a second pivot shaft;
wherein the first and second pivot shafts are laterally offset from the longitudinal axis of the bar in the same direction.

2. The windshield wiper assembly according to claim 1,
wherein the wiper motor has an output shaft, and
the output shaft is laterally offset from the longitudinal axis of the bar in the same direction as the first and second pivot shafts.

3. The windshield wiper assembly according to claim 2,
wherein the output shaft is located approximately linearly between the first and second pivot shafts.

4. The windshield wiper assembly according to claim 2,
wherein when a perpendicular distance from the first pivot shaft to the longitudinal axis of the bar is represented by D1, a perpendicular distance from the second pivot shaft to the longitudinal axis of the bar is represented by D2, and a perpendicular distance from the output shaft to the longitudinal axis of the bar is represented by D3, a relationship D2<D3<D1 is satisfied in a plane perpendicular to a longitudinal axis of the output shaft.

5. The windshield wiper assembly according to claim 1,
wherein the first pivot assembly has:
a first shaft holding portion pivotally supporting the first pivot shaft; and
a first offset arm extending from the first shaft holding portion to the first end of the bar; and
wherein the second pivot assembly has:
a second shaft holding portion pivotally supporting the second pivot shaft; and
a second offset arm extending from the second shaft holding portion to the second end of the bar.

6. The windshield wiper assembly according to claim 2,
wherein the output shaft is laterally offset from the longitudinal axis of the bar in a different direction as the first and second pivot shafts.

7. A windshield wiper assembly, comprising:
a wiper motor having a coupling portions, the coupling portions being disposed along an axis;
a bar coupled to the coupling portions;
a first pivot assembly coupled to a first end of the bar, the first pivot assembly having a first pivot shaft; and
a second pivot assembly coupled to a second end of the bar, the second pivot assembly having a second pivot shaft;
wherein the first and second pivot shaft are laterally offset from the axis of the coupling portions, and
the first and second pivot shafts are laterally offset in the same direction as the wiper motor relative to the axis.

8. The windshield wiper assembly according to claim 7,
wherein the wiper motor has an output shaft; and
the output shaft is laterally offset from the axis of the coupling portions in the same direction as the first and second pivot shafts.

9. The windshield wiper assembly according to claim 8,
wherein the output shaft is located approximately linearly between the first and second pivot shafts.

10. The windshield wiper assembly according to claim 8,
wherein when a perpendicular distance from the first pivot shaft to the axis of the coupling portions is represented by D1, a perpendicular distance from the second pivot shaft to the axis of the coupling portions is represented by D2, and a perpendicular distance from the output shaft to the axis of the coupling portions is represented by D3, a relationship D2<D3<D1 is satisfied in a plane perpendicular to a longitudinal axis of the output shaft.

11. The windshield wiper assembly according to claim 7,
wherein the first pivot assembly has:
a first shaft holding portion pivotally supporting the first pivot shaft; and
a first offset arm extending from the first shaft holding portion to a first end of the coupling portions; and
wherein the second pivot assembly has:
a second shaft holding portion pivotally supporting the second pivot shaft; and
a second offset arm extending from the second shaft holding portion to a second end of the coupling portions.

12. The windshield wiper assembly according to claim 11,
wherein the first offset arm is formed on the first shaft holding portion, and the second offset arm is formed on the second shaft holding portion.

13. The windshield wiper assembly according to claim 7,
wherein the bar has a first bending part and a second bending part, and the wiper motor is located between the first and second bending parts.

14. A windshield wiper assembly, comprising:
a wiper motor having a coupling portion;
a bar coupled to the coupling portion, the bar being elongated along a longitudinal axis;
pivot assemblies respectively coupled to opposite ends of the bar, the pivot assemblies having pivot shafts and shaft supporting portions pivotally supporting the pivot shafts; and
offset arms extending between the shaft supporting portions and the coupling portions.

15. A windshield wiper assembly, comprising:
a bar;
a wiper motor mounted on one side of the bar;
a pair of pivot shafts arranged on the one side of the bar.

16. The windshield wiper assembly according to claim 15, further comprising:
at least one offset arm extending from the bar toward an adjacent one of the pivot shafts.

17. The windshield wiper assembly according to claim 16, further comprising:
a pair of shaft holder portions pivotally supporting the pivot shafts; and
the offset arm integral with an adjacent one of the shaft holder portions.

18. The windshield wiper assembly according to claim 15, wherein
the bar is elongated along a longitudinal axis and has at least one offset part.

19. The windshield wiper assembly according to claim 18,
wherein the offset part includes a bent section.

20. The windshield wiper assembly according to claim 15,
wherein the wiper motor is located between the pivot shafts.
